(19) United States
(12) Patent Application Publication
(10) Pub. No.: US 2025/0245854 A1
(43) Pub. Date: Jul. 31, 2025

(54) ELECTRONIC SYSTEM AND METHOD OF OPERATING THE SAME FOR ESTIMATING THREE-DIMENSIONAL SPACE COORDINATES OF TARGET

(71) Applicant: ELECTRONICS AND TELECOMMUNICATIONS RESEARCH INSTITUTE, Daejeon (KR)

(72) Inventors: Whui KIM, Daejeon (KR); Young Bag Moon, Daejeon (KR); Seong Hee Park, Daejeon (KR); Juderk Park, Daejeon (KR); Geon Min Yeo, Daejeon (KR); Youngsu Cho, Daejeon (KR)

(21) Appl. No.: 18/999,076

(22) Filed: Dec. 23, 2024

(30) Foreign Application Priority Data
Jan. 25, 2024 (KR) 10-2024-0011795
Jun. 3, 2024 (KR) 10-2024-0072237

(51) Int. Cl. G06T 7/73; G06T 1/00; G06T 7/11; G06T 7/80; H04N 23/695

(52) U.S. Cl. CPC G06T 7/74; G06T 1/0014; G06T 7/11; G06T 7/85; H04N 23/695; G06T 2200/04; G06T 2207/10028

(57) ABSTRACT

Disclosed is an electronic system. The electronic system includes a camera device including a camera and a motor that rotates the camera, a first server device that provides the motor with an angle control signal for obtaining first image data corresponding to a first scene including a target object by the camera, and a second server device. The camera device is configured to rotate the camera based on the angle control signal, to obtain the first image data by the rotated camera, and to provide the first server device with the first image data and angle information indicating a rotation state of the camera. The second server device is configured to determine estimated candidate coordinates of coordinates, at which the target object is located, in three-dimensional (3D) space based on 3D map information and the angle information received from the first server device.

### CROSS-REFERENCE TO RELATED APPLICATIONS

This application claims priority under 35 U.S.C. § 119 to Korean Patent Application No. 10-2024-0011795 filed on Jan. 25, 2024, and No. 10-2024-0072237 filed on Jun. 3, 2024, in the Korean Intellectual Property Office, the disclosures of which are incorporated by reference herein in their entireties.

### BACKGROUND

Embodiments of the present disclosure described herein relate to an electronic system and an operating method thereof, and more particularly, relate to an electronic system for estimating three-dimensional (3D) spatial coordinates of a target object and an operating method thereof.

Nowadays, as camera modules have become more advanced, real-time high-resolution image may be collected. Accordingly, the industrial demand for systems capable of precisely estimating a location of a target object at a distance through real-time high-resolution image collection is increasing in various fields.

In general, the target object is located on a terrain with complex shapes. In such the environment, various approaches are being attempted to accurately estimate a location of the target object, but require the storage and processing of vast amounts of data, thereby requiring significant costs and consuming significant power. Accordingly, a method is needed to minimize the amount of computation and storage space required to estimate the location of the target object.

### SUMMARY

Embodiments of the present disclosure provide an electronic system for estimating 3D spatial coordinates of a target object and a method of operating the same.

According to an embodiment, an electronic system is provided. The electronic system includes a camera device including a camera and a motor that rotates the camera in at least one of a pan rotation direction and a tilt rotation direction, a first server device that provides the motor with an angle control signal for obtaining first image data corresponding to a first scene including a target object by the camera, and a second server device. The camera device is configured to rotate the camera in the pan rotation direction by a first angle and in the tilt rotation direction by a second angle based on the angle control signal, to obtain the first image data by the rotated camera, and to provide the first server device with the first image data and angle information indicating a rotation state of the camera. The second server device is configured to determine estimated candidate coordinates of coordinates, at which the target object is located, in three-dimensional (3D) space based on 3D map information and the angle information received from the first server device.

According to some embodiments of the present disclosure, the camera device is configured to provide the first server device with second image data corresponding to a second scene including the target object. The first server device includes a first processor including an image processing module that recognizes the target object in the second image data and detects pixel coordinates of the target object, and a motor control module that calculates a pixel error corresponding to a result of comparing the pixel coordinates with center pixel coordinates of the second image data, and generates the angle control signal based on the pixel error.

According to some embodiments of the present disclosure, the angle control signal includes a first angle control value and a second angle control value. The first angle control value corresponds to a difference in a first axis between the pixel coordinates and the center pixel coordinates, the second angle control value corresponds to a difference in a second axis between the pixel coordinates and the center pixel coordinates, and the first axis and the second axis are orthogonal to each other.

According to some embodiments of the present disclosure, the image processing module recognizes a plurality of objects in the second image data, and determines one of the plurality of objects as the target object.

According to some embodiments of the present disclosure, the motor includes an angle converter that rotates the camera in the pan rotation direction by the first angle and in the tilt rotation direction by the second angle, and a motor controller that determines the first angle and the second angle based on a structure of the angle converter and the angle control signal.

According to some embodiments of the present disclosure, the first server device provides the second server device with the angle information and a request signal for receiving the candidate coordinates. The second server device includes a second processor including a candidate region calculation module that determines a candidate region of the target object based on the angle information and the 3D map information in response to the request signal, and a candidate coordinate calculation module that determines the candidate coordinates based on the candidate region and the 3D map information. The candidate region indicates a location at which the second server device estimates that the target object is present in 3D space within the 3D map information.

According to some embodiments of the present disclosure, the candidate coordinate calculation module determines candidate coordinates located at regular intervals within the candidate region, and the candidate coordinates indicate estimated latitudes, longitudes, and altitudes of the coordinates at which the target object is located, respectively.

According to some embodiments of the present disclosure, the first server device is configured to calculate altitude angles between the candidate coordinates, coordinates of the camera device, and altitude correction coordinates of the candidate coordinates, respectively, to calculate angle errors between the altitude angles and the second angle, respectively, and to determine one of the candidate coordinates corresponding to a smallest one of the angle errors as the coordinates at which the target object is located. The altitude correction coordinates indicate coordinates corrected such that altitudes of the candidate coordinates are identical to an altitude of the camera device.

According to an embodiment, a method of operating an electronic system including a camera device, a first server device, and a second server device is provided. The operating method includes providing, by the first server device, the camera device with an angle control signal for obtaining first image data corresponding to a first scene including a target object, rotating, by the camera device, a camera of the camera device in a pan rotation direction by a first angle and in a tilt rotation direction by a second angle based on the angle control signal, obtaining, by the camera device, the first image data, providing, by the camera device, the first server device with the first image data and angle information indicating a rotation state of the camera, and determining, by the second server device, estimated candidate coordinates of coordinates, at which the target object is located, in 3D space based on 3D map information and the angle information received from the first server device.

According to some embodiments of the present disclosure, the providing of the camera device with the angle control signal for obtaining the first image data includes providing, the camera device, the first server device with second image data corresponding to a second scene including the target object, recognizing, by the first server device, the target object in the second image data, detecting, by the first server device, pixel coordinates of the target object, calculating, by the first server device, a pixel error corresponding to a result of comparing the pixel coordinates and center pixel coordinates of the second image data, generating, by the first server device, the angle control signal based on the pixel error, and providing, by the first server device, the angle control signal to the camera device.

According to some embodiments of the present disclosure, the determining of the estimated candidate coordinates of the coordinates, at which the target object is located, includes providing, by the first server device, the second server device with the angle information and a request signal for receiving the candidate coordinates, determining, by the second server device, a candidate region of the target object based on the angle information and the 3D map information in response to the request signal, wherein the candidate region indicates a location at which it is estimated that the target object is present on a 3D map within the 3D map information, and determining, by the second server device, the candidate coordinates based on the candidate region and the 3D map information.

According to some embodiments of the present disclosure, the operating method further includes calculating, by the first server device, altitude angles between the candidate coordinates, coordinates of the camera device, and altitude correction coordinates of the candidate coordinates, calculating angle errors between the altitude angles and the second angle respectively, and determining one of the candidate coordinates corresponding to a smallest one among the angle errors as the coordinate at which the target object is located, wherein the altitude correction coordinates are corrected such that altitudes of the candidate coordinates are identical to an altitude of the camera device.

### BRIEF DESCRIPTION OF THE FIGURES

The above and other objects and features of the present disclosure will become apparent by describing in detail embodiments thereof with reference to the accompanying drawings.

FIG. 1 is a block diagram of an electronic system, according to an embodiment of the present disclosure.

FIG. 2 is a flowchart for describing a method of operating an electronic system, according to an embodiment of the present disclosure.

FIG. 3 is a diagram for describing an electronic system, according to some embodiments of the present disclosure.

FIG. 4 is a drawing for describing a pan rotation direction and a tilt rotation direction, according to some embodiments of the present disclosure.

FIG. 5 is a diagram for describing image data obtained by a camera device operating according to some embodiments of the present disclosure.

FIG. 6 is a diagram for describing an electronic system, according to some embodiments of the present disclosure.

FIG. 7 is a diagram for describing a candidate region of a target object, according to some embodiments of the present disclosure.

FIG. 8 is a diagram for describing candidate coordinates of a target object, according to some embodiments of the present disclosure.

FIG. 9 is a drawing for describing an altitude angle, according to some embodiments of the present disclosure.

### DETAILED DESCRIPTION

Below, embodiments of the present disclosure will be described in detail and clearly to such an extent that an ordinary one in the art easily implements the present disclosure.

The terms “unit”, “module”, etc. to be used below and function blocks illustrated in drawings may be implemented in the form of a software component, a hardware component, or a combination thereof. Below, to describe the technical idea of the present disclosure clearly, a description associated with identical components will be omitted.

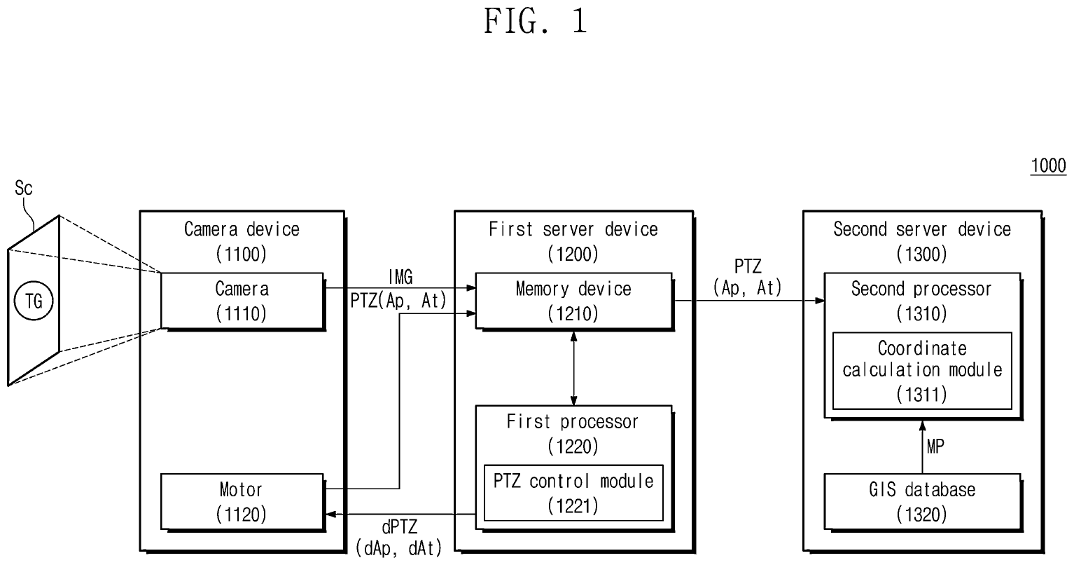

FIG. 1 is a block diagram of an electronic system, according to an embodiment of the present disclosure. Referring to FIG. 1, an electronic system 1000 may be a computing system configured to process various pieces of information or to store the processed information as data. In some embodiments, the electronic system 1000 may be a personal computer (PC), a notebook, a laptop, a server, a workstation, a tablet PC, a smartphone, a digital camera, and a black box.

The electronic system 1000 may determine coordinates at which a target object TG is located. For example, the electronic system 1000 may determine the coordinates (e.g., coordinates including latitude, longitude, and altitude) of the location of the target object TG in 3D space based on angle information PTZ.

To determine the coordinates of the location of the target object TG in the 3D space, a conventional electronic system may pre-store coordinates of surrounding feature points (e.g., large trees, roads, signs, and the like), and may estimate the coordinates of the target object TG based on the results of comparing the target object TG and the surrounding feature points.

The electronic system 1000 according to an embodiment of the present disclosure may determine the coordinates of the target object TG based on the angle information PTZ without comparing the target object TG with surrounding feature points, thereby reducing computing resources for recognizing surrounding feature objects and storage space for storing their coordinates.

The electronic system 1000 may include a camera device 1100, a first server device 1200, and a second server device 1300. The camera device 1100 may generate image data IMG and the angle information PTZ. For example, the camera device 1100 may generate the image data IMG corresponding to a scene Sc including the target object TG and the angle information PTZ indicating a state (a rotation state) in which the camera device 1100 is aligned with respect to the target object TG.

The camera device 1100 may include a camera 1110 and a motor 1120. The camera 1110 may obtain the image data IMG. For example, the camera 1110 may obtain the image data IMG corresponding to a scene placed in the direction in which the camera 1110 faces.

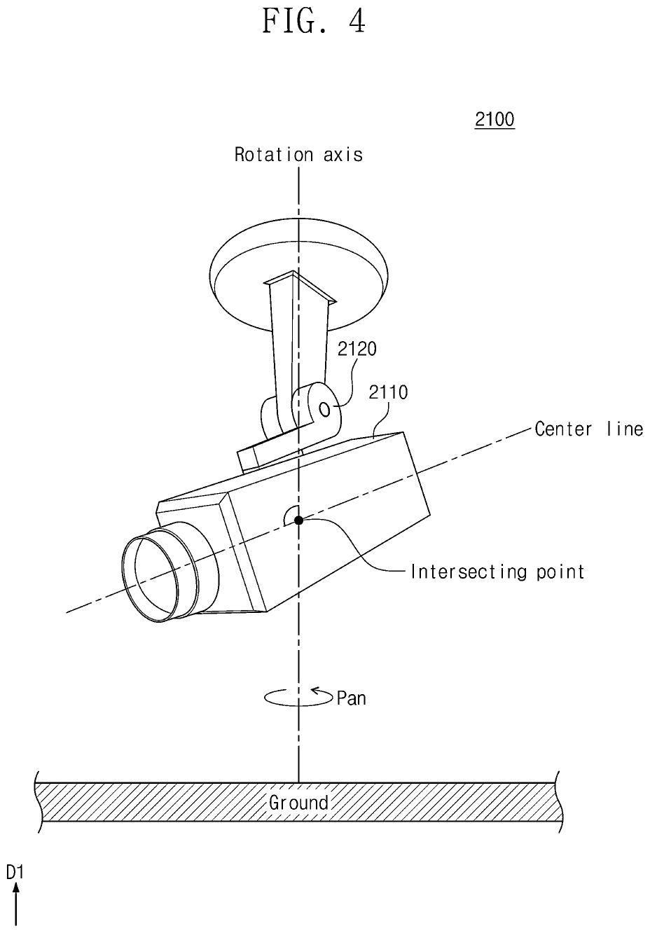

The motor 1120 may rotate the camera 1110. For example, the motor 1120 may rotate the camera 1110 in at least one of a pan rotation direction and a tilt rotation direction in a reference state (e.g., an initial state where the camera 1110 is not rotated in any direction). The pan rotation direction may refer to a direction horizontal to the ground, and the tilt rotation direction may refer to a direction perpendicular to the ground. The pan rotation direction and the tilt rotation direction may be orthogonal to each other. Detailed descriptions of the pan rotation direction and the tilt rotation direction will be described later with reference to FIG. 4.

In some embodiments, the motor 1120 may rotate the camera 1110 based on an angle control signal dPTZ. For example, the motor 1120 may rotate the camera 1110 in the pan rotation direction by a first angle and in the tilt rotation direction by a second angle based on the angle control signal dPTZ. In some embodiments, the motor 1120 may align the camera 1110 to the target object TG based on the angle control signal dPTZ. Aligning the camera 1110 with the target object TG may indicate that the camera 1110 is rotated such that pixel coordinates of the target object TG are located at the center within the image data IMG.

In some embodiments, the motor 1120 may provide the angle information PTZ to the first server device 1200. For example, the motor 1120 may provide the first server device 1200 with the angle information PTZ indicating the rotation state of the camera 1110. The rotation state of the camera 1110 may refer to a state rotated from the reference state in the pan rotation direction by a pan angle Ap and in the tilt rotation direction by a tilt angle At. That is, the angle information PTZ may include the pan angle Ap and the tilt angle At, which are angles in a state where the camera 1110 is aligned with respect to the target object TG.

The first server device 1200 may generate the angle control signal dPTZ. For example, the first server device 1200 may generate the angle control signal dPTZ based on the image data IMG. In some embodiments, when determining that the pixel coordinates of the target object TG are not located at the center of the image data IMG, the first server device 1200 may generate the angle control signal dPTZ such that the camera 1110 is aligned with respect to the target object TG. The angle control signal dPTZ may include a first angle control value dAp and a second angle control value dAt. The first server device 1200 may provide the angle control signal dPTZ to the camera device 1100.

In some embodiments, the first server device 1200 may provide the angle information PTZ to the second server device 1300. For example, the first server device 1200 may provide the second server device 1300 with the angle information PTZ including the pan angle Ap and the tilt angle At at a point in time when the camera 1110 is aligned with respect to the target object TG.

The first server device 1200 may include a memory device 1210 and a first processor 1220. The memory device 1210 may store data. For example, the memory device 1210 may store the image data IMG and the angle information PTZ. In some embodiments, in response to a request of the first processor 1220, the memory device 1210 may provide the image data IMG and the angle information PTZ to the first processor 1220, or may provide the angle information PTZ to the second server device 1300.

The memory device 1210 may be a volatile memory device. For example, the memory device 1210 may be a volatile memory device, in which stored data is lost when power is cut off, such as a Dynamic Random Access Memory (DRAM), a Static RAM (SRAM), or the like.

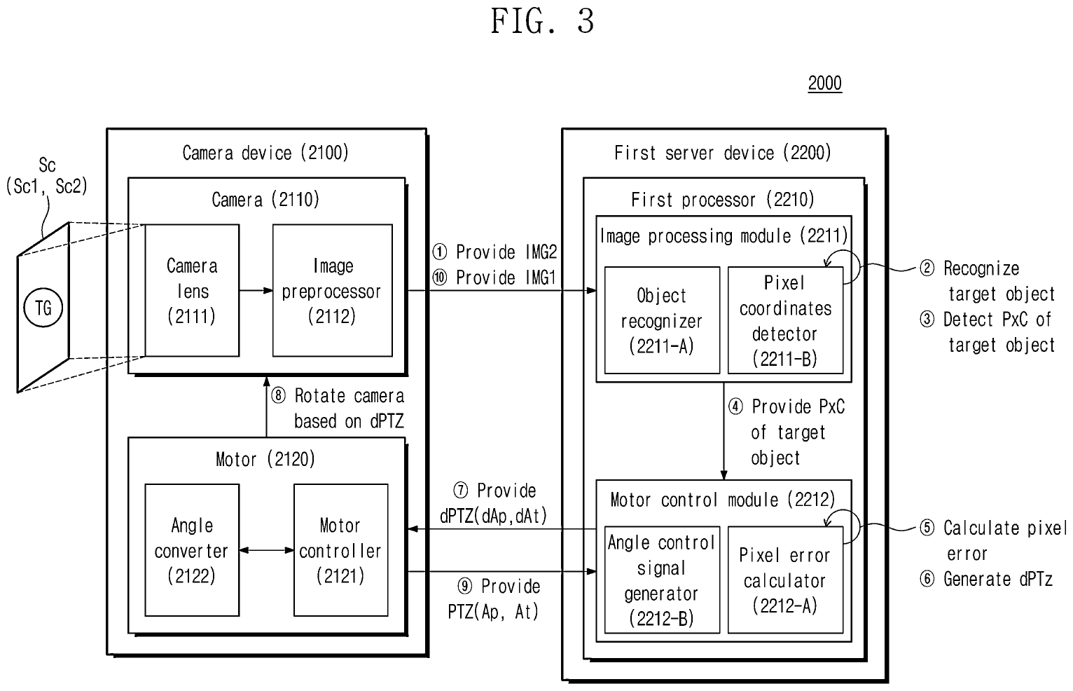

The first processor 1220 may be implemented with a Central Processing Unit (CPU), a Graphical Processing Unit (GPU), a Neural Processing Unit (NPU), a Tensor Processing Unit (TPU), a hardware accelerator, similar thereto, or a combination thereof. The first processor 1220 may include various modules. For example, the first processor 1220 may include a PTZ control module 1221. In some embodiments, the first processor 1220 may execute the PTZ control module 1221 based on the image data IMG received from the memory device 1210 and may generate the angle control signal dPTZ. Detailed descriptions of the PTZ control module 1221 will be described later with reference to FIG. 3.

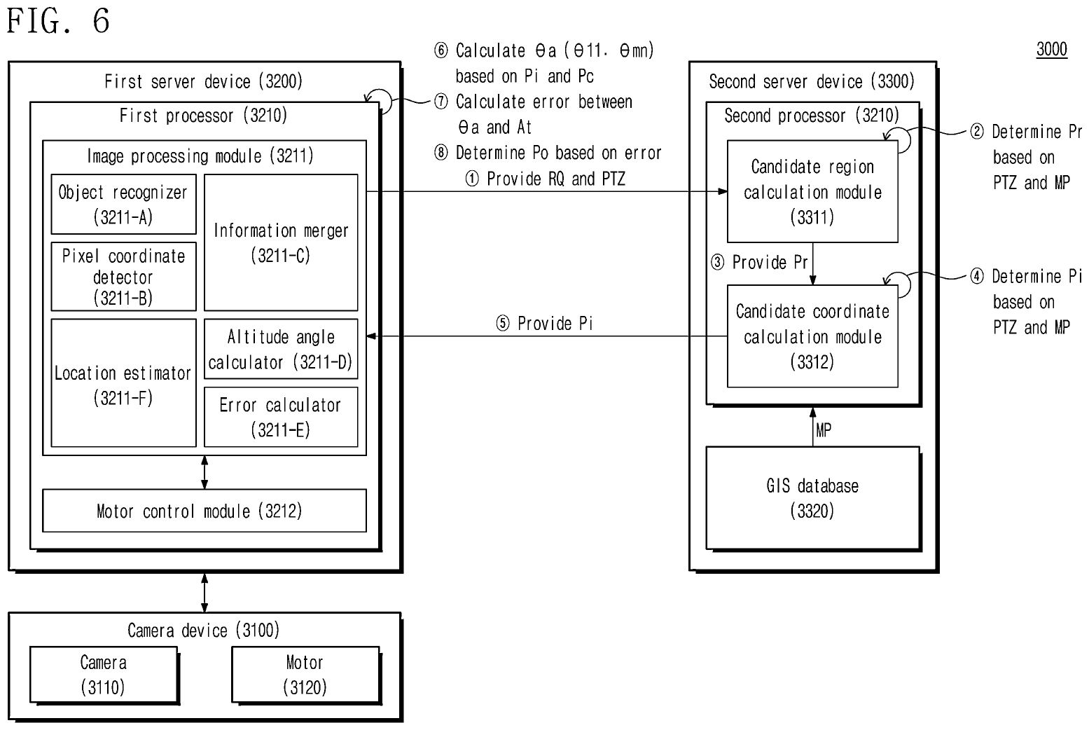

The second server device 1300 may determine candidate coordinates of coordinates where the target object TG is located. For example, the second server device 1300 may determine estimated candidate coordinates of the coordinates, in which the target object TG is located in 3D space, based on 3D map information MP and the angle information PTZ received from the first server device 1200. Detailed descriptions of the second server device 1300 will be described later with reference to FIG. 6.

The second server device 1300 may include a second processor 1310 and a Geographic Information System (GIS) database 1320. The second processor 1310 may be implemented with a CPU, a GPU, a NPU, a TPU, a hardware accelerator, similar thereto, or a combination thereof.

The second processor 1310 may include various modules. For example, the second processor 1310 may include a coordinate calculation module 1311. In some embodiments, the second processor 1310 may execute the coordinate calculation module 1311, and may determine the estimated candidate coordinates of the coordinates, in which the target object TG is located in the 3D space, based on the angle information PTZ received from the first server device 1200 and the 3D map information MP received from the GIS database 1320.

The GIS database 1320 may store the 3D map information MP. For example, the GIS database 1320 may store the 3D map information MP about the terrain (e.g., terrain within a distance of 10 km) around the coordinates (e.g., geographic coordinates including a location, a longitude, and an altitude) of the camera device 1100. The GIS database 1320 may provide the 3D map information MP to the second processor 1310 in response to a request of the second processor 1310.

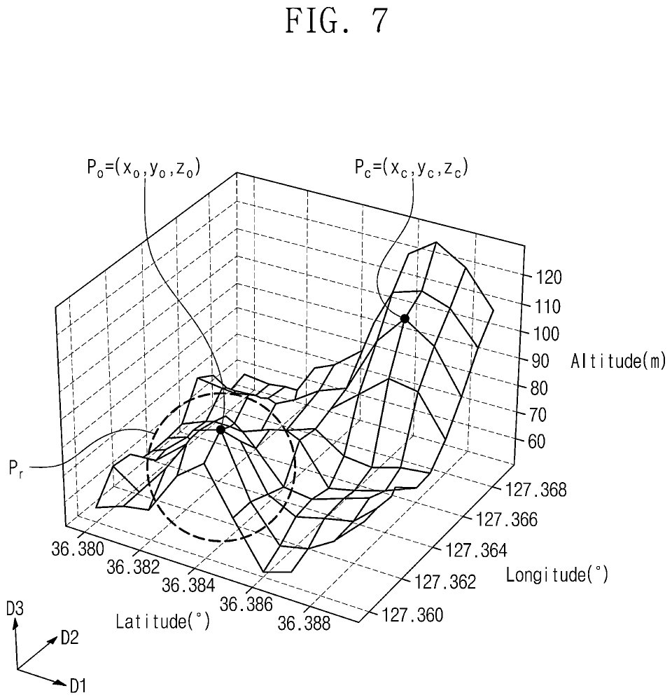

The 3D map information MP may be information about the terrain around the coordinates where the camera device 1100 is located. For example, the 3D map information MP may include information about the change in altitude depending on the latitude and the longitude of the terrain around the coordinates where the camera device 1100 is located. Detailed descriptions of the 3D map information MP will be described later with reference to FIGS. 7, 8, and 9.

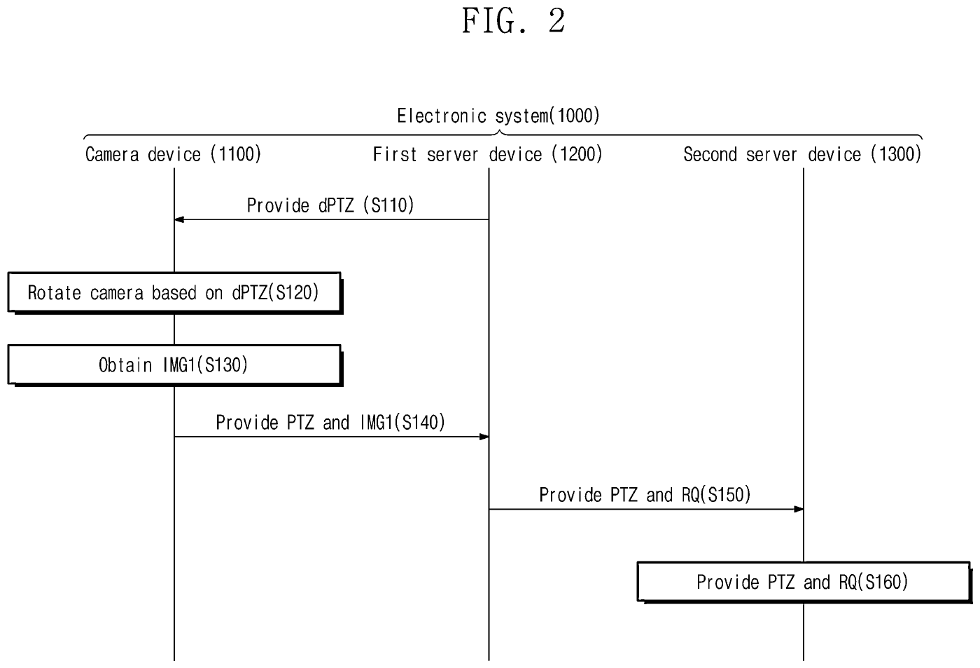

FIG. 2 is a flowchart for describing a method of operating an electronic system, according to an embodiment of the present disclosure. Referring to FIG. 2, the electronic system 1000 may include the camera device 1100, the first server device 1200, and the second server device 1300.

In operation S110, the first server device 1200 may provide the camera device 1100 with the angle control signal dPTZ. For example, the first server device 1200 may provide the camera device 1100 with the angle control signal dPTZ for obtaining a first image data IMG1 corresponding to a first scene including the target object TG of FIG. 1. In some embodiments, the first server device 1200 may provide the angle control signal dPTZ to the camera device 1100 such that the camera 1110 of FIG. 1 is aligned with respect to the target object TG.

In operation S120, the camera device 1100 may rotate the camera 1110 based on the angle control signal dPTZ. For example, the camera device 1100 may rotate the camera 1110 in a pan rotation direction by a first angle and in a tilt rotation direction by a second angle based on the angle control signal dPTZ.

In operation S130, the camera device 1100 may obtain the first image data IMG1. The first image data IMG1 may refer to an image in which the pixel coordinates of the target object TG are centered within the first image data IMG1.

In operation S140, the camera device 1100 may provide the angle information PTZ and the first image data IMG1 to the first server device 1200. For example, the camera device 1100 may provide the first server device 1200 with the angle information PTZ indicating the rotation state of the camera and the first image data IMG1. The angle information PTZ may include the pan angle Ap and the tilt angle At, which are angles in a state where the camera 1110 is aligned with respect to the target object TG.

In operation S150, the first server device 1200 may provide the second server device 1300 with the angle information PTZ and a request signal RQ for candidate coordinates Pᵢ of the target object TG.

In operation S160, the second server device 1300 may determine candidate coordinates Pᵢ of the target object TG based on the 3D map information MP and the angle information PTZ. For example, the second server device 1300 may determine the estimated candidate coordinates Pᵢ of the coordinates, in which the target object TG is located in 3D space, based on the 3D map information MP and the angle information PTZ received from the first server device 1200.

FIG. 3 is a diagram for describing an electronic system, according to some embodiments of the present disclosure. Referring to FIG. 3, an electronic system 2000 may include a camera device 2100 and a first server device 2200. The camera device 2100 and the first server device 2200 are partially similar to the camera device 1100 and the first server device 1200 of FIG. 1, and thus redundant descriptions are omitted.

The camera device 2100 may include a camera 2110 and a motor 2120. The camera 2110 may obtain the image data IMG corresponding to the scene Sc including the target object TG. For example, the camera 2110 may obtain the first image data IMG1 corresponding to a first scene Sc1 including the target object TG and a second image data IMG2 corresponding to a second scene Sc2. The first scene Sc1 and the second scene Sc2 may be the same as or different from each other.

In some embodiments, the camera 2110 may obtain the second image data IMG2 corresponding to the second scene Sc2 in a state where it is rotated in a pan rotation direction by a third angle and in a tilt rotation direction by a fourth angle from a reference state. Moreover, the camera 2110 may obtain the first image data IMG1 corresponding to the first scene Sc1 in a state where it is further rotated in the pan rotation direction by a first angle and in the tilt rotation direction by a second angle (i.e., a state where it is rotated in the pan rotation direction by a pan angle and in the tilt angle by a tilt rotation angle in a reference state). The first image data IMG1 may be obtained when the camera 2110 is aligned with respect to the target object TG, and the second image data IMG2 may be obtained when the camera 2110 is not aligned with respect to the target object TG.

In some embodiments, the camera 2110 may provide the second image data IMG2 to the first server device 2200. For example, the camera 2110 may obtain the second image data IMG2 corresponding to the second scene Sc2 including the target object TG in a state where it is rotated in the pan rotation direction by the third angle and in the tilt rotation direction by the fourth angle in the reference state, and may provide the second image data IMG2 to the first server device 2200.

The camera 2110 may include a camera lens 2111 and an image preprocessor 2112. The camera lens 2111 may convert a scene corresponding to the scene Sc including the target object TG into data. Furthermore, the image preprocessor 2112 may obtain image data by preprocessing data (e.g., the first image data IMG1 or the second image data IMG2) converted by the camera lens 2111.

The motor 2120 may rotate the camera 2110 based on the angle control signal dPTZ. For example, the motor 2120 may receive the angle control signal dPTZ including the first angle control value dAp and the second angle control value dAt from the first server device 2200, and may rotate the camera 2110 in the pan rotation direction and the tilt rotation direction based on the angle control signal dPTZ.

The motor 2120 may include a motor controller 2121 and an angle converter 2122. The motor controller 2121 may determine a first angle and a second angle based on the angle control signal dPTZ. For example, the motor controller 2121 may determine the first angle, at which the camera 2110 needs to be specifically rotated in the pan rotation direction, based on the first angle control value dAp. Besides, the motor controller 2121 may determine the second angle, at which the camera 2110 needs to be specifically rotated in the tilt rotation direction, based on the second angle control value dAt.

In some embodiments, the motor controller 2121 may provide the angle information PTZ of the camera 2110 to the first server device 2200. For example, the motor controller 2121 may provide the first server device 1200 with the angle information PTZ indicating a state where the camera 1110 is rotated in the pan rotation direction by the pan angle Ap and in the tilt rotation direction by the tilt angle At. In some embodiments, when the motor controller 2121 further rotates the camera 2110 by a first angle and a second angle based on the angle control signal dPTZ in a state where the camera 2110 is rotated in the pan rotation direction by a third angle and in the tilt rotation direction by a fourth angle, the pan angle Ap may correspond to the sum of the third angle and the first angle, and the tilt angle At may correspond to the sum of the fourth angle and the second angle.

The angle converter 2122 may rotate the camera 2110. For example, the angle converter 2122 may rotate the camera 2110 so as to rotate in the pan rotation direction by the first angle and in the tilt rotation direction by the second angle under the control of the motor controller 2121. In other words, the angle converter 2122 may rotate the camera 2110 such that the camera 2110 is aligned with respect to the target object TG, under the control of the motor controller 2121.

The first server device 2200 may include a first processor 2210. For example, the first server device 2200 may include the first processor 2210 configured to generate the angle control signal dPTZ based on image data (e.g., the first image data IMG1).

In some embodiments, the first processor 2210 may include an image processing module 2211 and a motor control module 2212. The image processing module 2211 may detect pixel coordinates P×C of the target object TG based on the first image data IMG1. The image processing module 2211 may include an object recognizer 2211-A and a pixel coordinate detector 2211-B. The object recognizer 2211-A may recognize the target object TG in the image data. For example, the object recognizer 2211-A may recognize the target object TG in the second image data IMG2 received from the camera device 2100. In some embodiments, the object recognizer 2211-A may recognize the target object TG among the target object TG and the remaining objects in the second image data IMG2 corresponding to the second scene Sc2 including the target object TG.

In some embodiments, the object recognizer 2211-A may recognize a plurality of objects in the second image data IMG2, and may determine one of the plurality of objects as the target object TG. For example, the second scene Sc2 may include a plurality of objects including the target object TG, and the object recognizer 2211-A may first recognize the plurality of objects in the second image data IMG2, and then may determine one of the plurality of objects as the target object TG.

The pixel coordinate detector 2211-B may detect the pixel coordinates P×C of the target object TG. For example, the pixel coordinate detector 2211-B may detect the pixel coordinates P×C of the target object TG in the second image data IMG2. The pixel coordinates P×C of the target object TG may indicate the pixel coordinates P×C of the center of the target object TG, but this is an example and the present disclosure is not limited thereto.

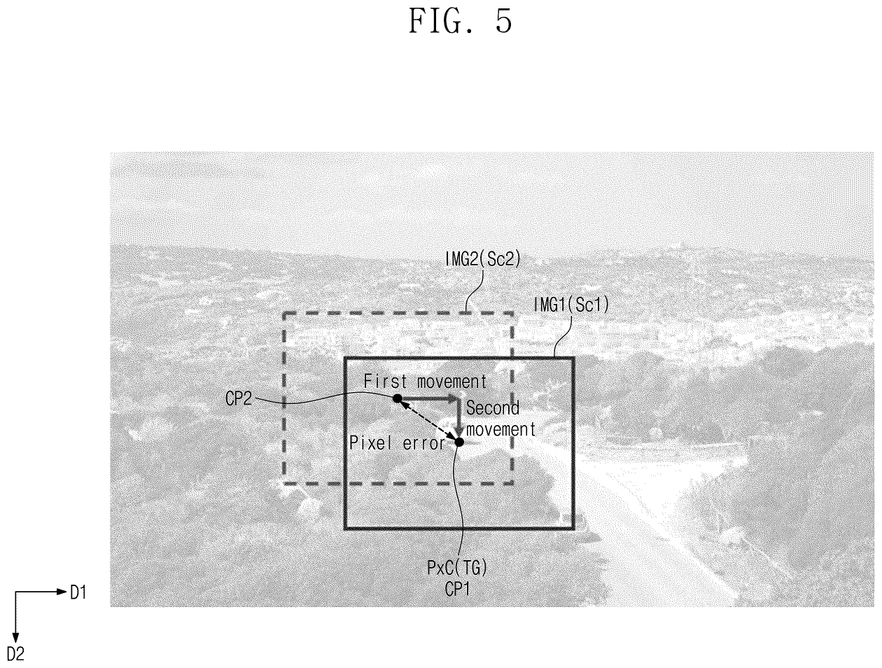

The pixel coordinates P×C may be coordinates in a two-dimensional (2D) space indicating the location of a specific pixel among pixels constituting image data. For example, when the second image data IMG2 consists of 1,000 pixels in a horizontal axis and 1,000 pixels in a vertical axis (i.e., when the second image data IMG2 consists of a total of 1,000,000 pixels), the pixel coordinates P×C of the target object TG may be expressed as (x, y). ‘x’ and ‘y’ are not negative integers. Detailed descriptions of the pixel coordinates P×C will be described later with reference to FIG. 5.

The motor control module 2212 may generate the angle control signal dPTZ based on the pixel coordinates P×C of the target object TG. The motor control module 2212 may include a pixel error calculator 2212-A and an angle control signal generator 2212-B. The pixel error calculator 2212-A may calculate the pixel error of the target object TG. For example, the pixel error calculator 2212-A may calculate a pixel error corresponding to the result of comparing the pixel coordinates P×C of the target object TG and the center pixel coordinates of the image data (e.g., the second image data IMG2). The center pixel coordinates may refer to the coordinates at the center of the 2D space of the second image data IMG2.

In some embodiments, the pixel error calculator 2212-A may compare the pixel coordinates P×C of the target object TG with the center pixel coordinates of the second image data IMG2 on both a horizontal axis and a vertical axis, and may calculate a pixel error corresponding to the comparison result. For example, when the second image data IMG2 consists of 1000×1000 pixels (i.e., the second image data IMG2 consists of 1,000 pixels on the horizontal axis and 1,000 pixels on the vertical axis), and the pixel coordinates P×C of the target object TG are (x, y), the pixel error calculator 2212-A may calculate that the pixel error is (x-500, y-500).

The angle control signal generator 2212-B may generate the angle control signal dPTZ based on the pixel error. For example, the angle control signal generator 2212-B may generate the first angle control value dAp based on an element (e.g., x-500) on the horizontal axis of the pixel error, and may generate the second angle control value dAt based on an element (e.g., y-500) on the vertical axis of the pixel error. In other words, the first angle control value dAp may correspond to a difference in the horizontal axis between the pixel coordinates P×C and the center pixel coordinates of the target object TG, and the second angle control value dAt may correspond to a difference in the vertical axis between the pixel coordinates P×C and the center pixel coordinates. The angle control signal generator 2212-B may provide the angle control signal dPTZ to the camera device 2100.

FIG. 4 is a drawing for describing a pan rotation direction and a tilt rotation direction, according to some embodiments of the present disclosure. Referring to FIG. 4, the camera device 2100 may include the camera 2110 and the motor 2120.

A pan rotation direction may correspond to a clockwise direction of the camera 2110 around a rotation axis perpendicular to the ground. In other words, the motor 2120 rotating the camera 2110 in a pan rotation direction by a first angle may correspond to the motor 2120 rotating the camera 2110 in the clockwise direction by the first angle around the rotation axis.

A tilt rotation direction may correspond to a first direction D1 of the front surface portion of the camera 2110 based on an intersecting point between the rotation axis and the center line. In other words, the motor 2120 rotating the camera 2110 in the tilt rotation direction by a second angle may correspond to the motor 2120 rotating the camera 2110 in the first direction D1 around the intersecting point between the rotation axis and the center line.

FIG. 5 is a diagram for describing image data obtained by a camera device operating according to some embodiments of the present disclosure. Referring to FIG. 5, the camera device 2100 of FIG. 3 may obtain the first image data IMG1 and the second image data IMG2 respectively corresponding to the first scene Sc1 and the second scene Sc2 including the target object TG. The first scene Sc1 may include the target object TG in a first center pixel coordinates CP1, but the second scene Sc2 may not include the target object TG in a second center pixel coordinates CP2.

In some embodiments, when the camera 2110 is not aligned with respect to the target object TG, the camera device 2100 of FIG. 3 may obtain the second image data IMG2 corresponding to the second scene Sc2. Next, the first server device 2200 of FIG. 3 may detect a pixel error based on the second image data IMG2, and may generate the angle control signal dPTZ for aligning the camera 2110 with respect to the target object TG. Accordingly, the motor 2120 of FIG. 3 may align the camera 2110 with respect to the target object TG based on the angle control signal dPTZ (e.g., first movement and second movement), and the camera 2110 may obtain the first image data IMG1 corresponding to the first scene Sc1.

There may be a pixel error between the second center pixel coordinates CP2 of the second image data IMG2 and the pixel coordinates P×C of the target object TG. In some embodiments, the first server device 2200 of FIG. 3 may calculate the pixel error of the second image data IMG2, and may generate the angle control signal dPTZ based on the calculated pixel error. Then, the motor 2120 of FIG. 3 may rotate the camera 2110 in a pan rotation direction by a first angle (corresponding to the first movement) and in a tilt rotation direction by a second angle (corresponding to the second movement) based on the angle control signal dPTZ, and the camera 2110 may obtain the first image data IMG1 corresponding to the first scene Sc1.

As the motor 2120 of FIG. 3 rotates the camera 2110 based on the angle control signal dPTZ, the center pixel coordinates of the image data may move from the second center pixel coordinates CP2 to the first center pixel coordinates CP1. For example, the motor 2120 of FIG. 3 rotates the camera 2110 in the pan rotation direction by the first angle based on the angle control signal dPTZ, which may correspond to the first movement in the first direction D1. Moreover, the motor 2120 of FIG. 3 rotates the camera 2110 in the tilt rotation direction by the second angle based on the angle control signal dPTZ, which may correspond to the second movement in a second direction D2. Accordingly, as the result of performing both the first movement and the second movement, the target object TG may be located at the first center pixel coordinates CP1.

The first center pixel coordinates CP1 of the first image data IMG1 may be identical to the pixel coordinates P×C of the target object TG. In other words, when the camera 2110 of FIG. 3 is aligned with respect to the target object TG, the first center pixel coordinates CP1 of the first image data IMG1 may be identical to the pixel coordinates P×C of the target object TG.

FIG. 6 is a diagram for describing an electronic system, according to some embodiments of the present disclosure. Referring to FIG. 6, an electronic system 3000 may include a camera device 3100, a first server device 3200, and a second server device 3300. The first server device 3200 is partially similar to the first server device 1200 of FIG. 1 and the first server device 2200 of FIG. 3, and the second server device 3300 is partially similar to the second server device 1300 of FIG. 1, and thus redundant descriptions are omitted.

The first server device 3200 may include a first processor 3210. The first processor 3210 may include an image processing module 3211 and a motor control module 3212. The image processing module 3211 may determine an actual location Pₒ of a target object. For example, the image processing module 3211 may provide the second server device 3300 with the angle information PTZ and the request signal RQ for the candidate coordinates Pᵢ, and may determine the actual location Pₒ of the target object based on the candidate coordinates Pi.

The image processing module 3211 may include an object recognizer 3211-A, a pixel coordinate detector 3211-B, an information merger 3211-C, an altitude angle calculator 3211-D, an error calculator 3211-E, and a location estimator 3211-F. The object recognizer 3211-A and the pixel coordinate detector 3211-B are similar to the object recognizer 2211-A and the pixel coordinate detector 2211-B of FIG. 3, respectively, and thus redundant descriptions are omitted. The pixel coordinate detector 3211-B may determine that the pixel coordinates of the target object are the same as the center pixel coordinates of image data.

The information merger 3211-C may provide the second server device 3300 with the angle information PTZ and the request signal RQ for the candidate coordinates Pᵢ. For example, the information merger 3211-C may receive the angle information PTZ from the motor control module 3212 (or a memory device (not shown) of the first server device 3200), and may provide the second server device 3300 with the angle information PTZ and the request signal RQ for the candidate coordinates Pᵢ of the target object in response to the pixel coordinate detector 3211-B determining that the pixel coordinates of the target object are the same as the center pixel coordinates of the image data.

The altitude angle calculator 3211-D may calculate altitude angles θₐ based on the candidate coordinates Pᵢ of the target object. The altitude angles θₐ correspond to the results of comparing the altitude of the candidate coordinates Pᵢ and the altitude of the camera device 3100, respectively. For example, the altitude angles θₐ may correspond to angles between a first group of straight lines connecting the coordinates of the candidate coordinates Pᵢ to the coordinates of the camera device 3100, and a second group of straight lines connecting the altitude correction coordinates (i.e., coordinates corrected such that altitudes of the candidate coordinates Pi are the same as the altitude of the camera device 3100) of the candidate coordinates Pi to coordinates P_{c} of the camera device 3100.

In some embodiments, when any candidate location among the candidate coordinates Pᵢ is Pₘₙ, Pₘₙ may be expressed as shown in Equation 1 below.

$${P}_{mn} = \{ ( {x}_{mn} , {y}_{mn} , {z}_{mn} ) \vert m = 1 , 2 , … , M , n = 1 , 2 , … , N \} \qquad [ Equation 1 ]$$

xₘₙ, yₘₙ, and zₘₙ are the latitude, longitude, and altitude of Pₘₙ, respectively, and ‘M’ and ‘N’ are natural numbers.

Altitude angle θₘₙ of the candidate coordinates Pₘₙ may be calculated by using Equation 2 below.

$$\begin{matrix}{θ}_{mn} = {sin}^{- 1} ( \frac{\text{?}}{\text{?}} ) \\ = {sin}^{- 1} ( \frac{\sqrt{{( {z}_{c} - {z}_{mn} )}^{2}}}{\sqrt{{( {x}_{c} - {x}_{mn} )}^{2} + {( {y}_{c} - {y}_{mn} )}^{2} + {( {z}_{c} - {z}_{mn} )}^{2}}} )\end{matrix} \qquad [ Equation 2 ]$$

$$\text{?} \text{indicates text missing or illegible when filed}$$

P′ₘₙ denotes the altitude correction coordinates (i.e., coordinates corrected such that the altitude of the arbitrary candidate location is the same as the altitude of the camera device 3100) of the arbitrary candidate coordinates Pₘₙ.

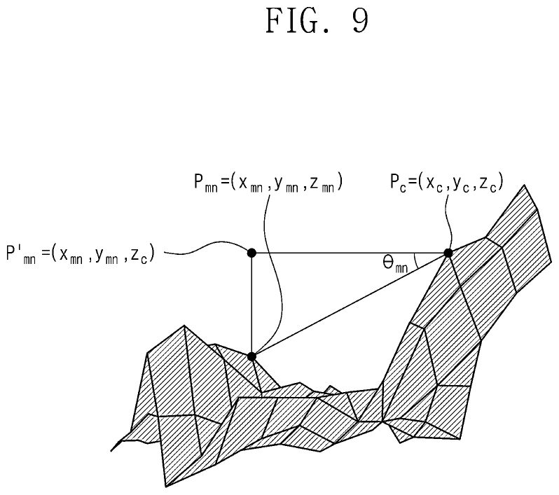

In some embodiments, according to Equation 2, the altitude angle calculator 3211-D may calculate the altitude angles θₐ of the candidate coordinates Pᵢ based on the candidate coordinates Pᵢ received from the second server device 3300 and the coordinates P_{c} of the camera device 3100. Detailed descriptions of the altitude angles θₐ will be described later with reference to FIG. 9.

The error calculator 3211-E may calculate angle errors. For example, the error calculator 3211-E may calculate angle errors corresponding to differences between a tilt angle (i.e., an angle by which a camera 3110 is rotated in a tilt rotation direction when the camera 3110 is aligned with respect to the target object) of the camera device 3100 and the altitude angles θₐ, respectively.

The location estimator 3211-F may determine the coordinates of the target object. For example, the location estimator 3211-F may determine one of the candidate coordinates Pᵢ corresponding to the smallest angle error among a plurality of angle errors as coordinates at which the target object is located. In other words, the location estimator 3211-F may determine the candidate location having the smallest difference between the angle error and the tilt angle as the coordinates of the target object.

The second server device 3300 may include a second processor 3310 and a GIS database 3320. The second processor 3310 may include a candidate region calculation module 3311 and a candidate coordinate calculation module 3312. The candidate region calculation module 3311 may determine a candidate region Pᵣ of the target object. For example, the candidate region calculation module 3311 may determine the candidate region Pᵣ based on the angle information PTZ and the 3D map information MP in response to the request signal RQ. The candidate region Pᵣ may indicate a region, in which the target object is capable of being present, in 3D space.

In some embodiments, the candidate region calculation module 3311 may determine the candidate region Pᵣ based on the coordinates P_{c} of the camera device 3100 and a pan angle and a tilt angle, which are included in the angle information PTZ. For example, the candidate region calculation module 3311 may determine a region centered on coordinates in the 3D space, which is connected by a straight line from the coordinates P_{c} of the camera device 3100 at the pan angle and the tilt angle, as the candidate region Pᵣ.

The candidate coordinate calculation module 3312 may determine the candidate coordinates Pᵢ. For example, the candidate coordinate calculation module 3312 may determine the candidate coordinates Pᵢ from the candidate region Pᵣ based on the 3D map information MP. The candidate coordinates Pᵢ may indicate the estimated latitudes, longitudes, and altitudes of coordinates, at which the target object is capable of being located, respectively. The candidate coordinate calculation module 3312 may provide the candidate coordinates Pᵢ to the first server device 3200.

In some embodiments, the candidate coordinate calculation module 3312 may determine the candidate coordinates Pᵢ that are located at regular intervals within the candidate region Pᵣ. For example, the candidate coordinate calculation module 3312 may determine the candidate coordinates Pᵢ that are located at regular intervals in the 3D space (in latitude, longitude, or altitude) within the candidate region Pᵣ.

FIG. 7 is a diagram for describing a candidate region of a target object, according to some embodiments of the present disclosure. Referring to FIG. 7, the candidate region Pᵣ of a target object may be the estimated region of the actual location Pₒ of the target object in 3D space. An axis of the first direction D1 is latitude; an axis of the second direction D2 is longitude; and an axis of a third direction D3 is altitude. The unit of each of the latitude and the longitude are degrees (°), and the unit of the altitude is meters (m).

The actual location Pₒ of the target object and the coordinates P_{c} of the camera device may be expressed as coordinates on the 3D space including latitude, longitude, and altitude, respectively. For example, the actual location Pₒ of the target object may be expressed as (xₒ, yₒ, zₒ), and the coordinates P_{c} of the camera device may be expressed as (x_{c}, y_{c}, z_{c}). xₒ, yₒ, zₒ, x_{c}, y_{c}, and z_{c} are real numbers. Moreover, the candidate region Pᵣ may be a set of points in 3D or a region composed of a surface.

In some embodiments, the candidate region Pᵣ of the target object may be a region centered on coordinates, which are viewed by the camera 2110 of FIG. 3 based on the angle information PTZ. For example, the candidate region Pᵣ of the target object may be a region in the 3D space centered on coordinates, which are viewed from the coordinates P_{c} of the camera device by the camera 2110 of FIG. 3 based on a pan angle and a tilt angle of the angle information PTZ. The angle information PTZ may indicate angles rotated by a pan rotation angle and a tilt rotation angle such that the camera 2110 of FIG. 3 is aligned with respect to the target object.

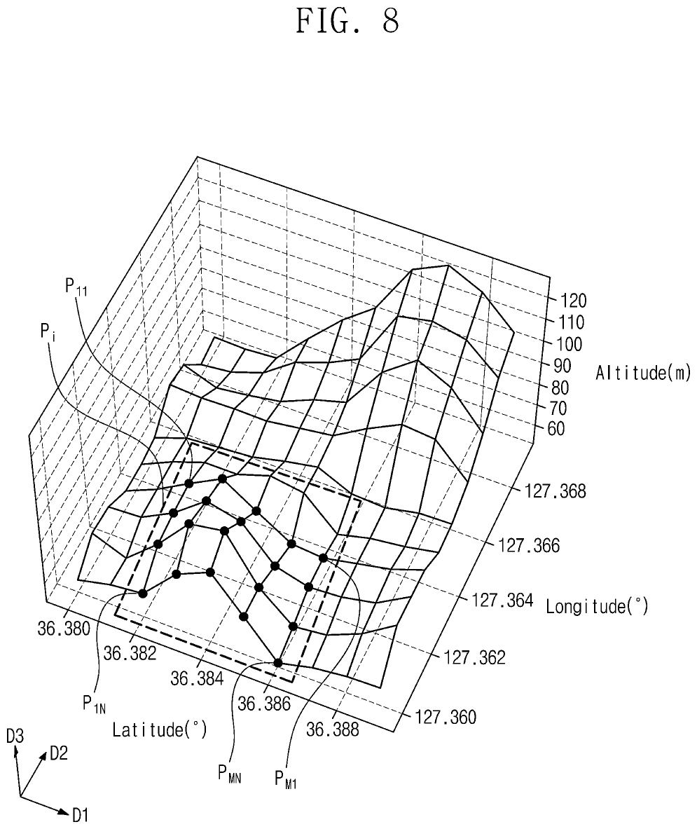

FIG. 8 is a diagram for describing candidate coordinates of a target object, according to some embodiments of the present disclosure. The candidate coordinates Pᵢ may be coordinates, which have regular intervals and are located within the candidate region Pᵣ of FIG. 7. An axis of the first direction D1 is latitude; an axis of the second direction D2 is longitude; and an axis of the third direction D3 is altitude. The unit of each of the latitude and the longitude are degrees (°), and the unit of the altitude is meters (m).

The candidate coordinates Pᵢ may include M×N coordinates P₁₁ to P_{MN}. (M−1) candidate coordinates that has regular intervals in 3D space in the first direction D1 may be located between P₁₁ and P_{M1}. Moreover, (N−1) candidate coordinates that has regular intervals in the 3D space in the second direction D2 may be located between P₁₁ and P_{1N}. Each of ‘M’ and ‘N’ is a natural number.

In some embodiments, the first server device 3200 of FIG. 6 may determine an actual location of the target object among the candidate coordinates Pᵢ. For example, the first server device 3200 of FIG. 6 may receive the candidate coordinates Pᵢ from the second server device 3300 of FIG. 6, and may calculate the altitude angles of the candidate coordinates Pᵢ based on Equation 2. Next, the first server device 3200 of FIG. 6 may calculate angle errors corresponding to the results of comparing the altitude angles with a tilt angle, and may determine a candidate location having the smallest angle error as the actual location of the target object.

FIG. 9 is a drawing for describing an altitude angle, according to some embodiments of the present disclosure. Referring to FIG. 9, the arbitrary altitude angle θₘₙ may be an angle between a first straight line connecting the coordinates P_{c} of a camera device and the arbitrary candidate coordinates Pₘₙ of a target object and a second straight line connecting the coordinates P_{c} of the camera device and arbitrary altitude correction coordinates P′ₘₙ of the target object. The arbitrary altitude angle θₘₙ may be calculated according to Equation 2.

In some embodiments, the arbitrary candidate coordinates Pₘₙ may be any one of the candidate coordinates Pᵢ in FIG. 8. Furthermore, the arbitrary candidate coordinates Pₘₙ may be expressed as (xₘₙ, yₘₙ, zₘₙ). xₘₙ denotes latitude; yₘₙ denotes longitude; and zₘₙ denotes altitude. Accordingly, the arbitrary altitude angle θₘₙ may be an altitude angle corresponding to any one of the candidate coordinates Pᵢ in FIG. 8. In other words, there may be a plurality of altitude angles respectively corresponding to the candidate coordinates P₁₁ to Pₘₙ included in the candidate coordinates Pᵢ of FIG. 8.

In some embodiments, the arbitrary altitude correction coordinates P′ₘₙ may be coordinates corrected such that the altitude of the arbitrary candidate coordinates Pₘₙ is the same as the altitude of the coordinates P_{c} of the camera device. For example, when the coordinates P_{c} of the camera device are (x_{c}, y_{c}, z_{c}), the arbitrary altitude correction coordinates P′ₘₙ may be expressed as (xₘₙ, yₘₙ, z_{c}). The arbitrary altitude correction coordinates P′ₘₙ may be needed to calculate an altitude angle according to Equation 2.

The arbitrary altitude angle θₘₙ may be determined based on the coordinates P_{c} of the camera device, the arbitrary candidate coordinates Pₘₙ, and the arbitrary altitude correction coordinates P′ₘₙ. For example, the arbitrary altitude angle θₘₙ may correspond to the result calculated by substituting the coordinates P_{c} of the camera device, the arbitrary candidate coordinates Pₘₙ of the target object, and the arbitrary altitude correction coordinates P′ₘₙ of the target object into Equation 2.

In some embodiments, similarly to determining the arbitrary altitude angle θₘₙ corresponding to the arbitrary candidate coordinates Pₘₙ, the first server device 3200 of FIG. 6 may determine the altitude angles θₐ corresponding to the received candidate coordinates Pᵢ. For example, the first server device 3200 of FIG. 6 may determine the altitude correction coordinates of the received candidate coordinates Pᵢ and may determine the altitude angles between straight lines connecting the coordinates P_{c} of the camera device, the candidate coordinates Pᵢ, and the altitude correction coordinates.

The above description refers to detailed embodiments for carrying out the present disclosure. The present disclosure may include embodiments in which a design is changed simply or which are easily changed, as well as the embodiments described above. In addition, technologies that are easily changed and implemented by using the above embodiments may be included in the present disclosure. While the present disclosure has been described with reference to embodiments described above, it will be apparent to those of ordinary skill in the art that various changes and modifications may be made thereto without departing from the spirit and scope of the present disclosure as set forth in the following claims.

According to an embodiment of the present disclosure, an electronic system for estimating 3D spatial coordinates of a target object and a method of operating the same are provided.

Moreover, an electronic system and an operating method thereof are provided to estimate the exact location of a target object by calculating coordinates of the target object based on 3D map information, a high-definition image, and a rotation angle of a camera.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An electronic system comprising:
a camera device including a camera and a motor configured to rotate the camera in at least one of a pan rotation direction and a tilt rotation direction;
a first server device configured to provide the motor with an angle control signal for obtaining first image data corresponding to a first scene including a target object by the camera; and
a second server device,
wherein the camera device is configured to:
rotate the camera in the pan rotation direction by a first angle and in the tilt rotation direction by a second angle based on the angle control signal;
obtain the first image data by the rotated camera; and
provide the first server device with the first image data and angle information indicating a rotation state of the camera, and
wherein the second server device is configured to:
determine estimated candidate coordinates of coordinates, at which the target object is located, in three-dimensional (3D) space based on 3D map information and the angle information received from the first server device.

2. The electronic system of claim 1, wherein the camera device is configured to:
provide the first server device with second image data corresponding to a second scene including the target object, and
wherein the first server device includes a first processor including:
an image processing module configured to recognize the target object in the second image data and to detect pixel coordinates of the target object; and
a motor control module configured to calculate a pixel error corresponding to a result of comparing the pixel coordinates with center pixel coordinates of the second image data, and to generate the angle control signal based on the pixel error.

3. The electronic system of claim 2, wherein the angle control signal includes a first angle control value and a second angle control value, and
wherein the first angle control value corresponds to a difference in a first axis between the pixel coordinates and the center pixel coordinates, the second angle control value corresponds to a difference in a second axis between the pixel coordinates and the center pixel coordinates, and the first axis and the second axis are orthogonal to each other.

4. The electronic system of claim 2, wherein the image processing module recognizes a plurality of objects in the second image data, and determines one of the plurality of objects as the target object.

5. The electronic system of claim 1, wherein the motor includes:
an angle converter configured to rotate the camera in the pan rotation direction by the first angle and in the tilt rotation direction by the second angle; and
a motor controller configured to determine the first angle and the second angle based on a structure of the angle converter and the angle control signal.

6. The electronic system of claim 1, wherein the first server device provides the second server device with the angle information and a request signal for receiving the candidate coordinates,
wherein the second server device includes a second processor including:
a candidate region calculation module configured to determine a candidate region of the target object based on the angle information and the 3D map information in response to the request signal; and
a candidate coordinate calculation module configured to determine the candidate coordinates based on the candidate region and the 3D map information, and
wherein the candidate region indicates a location at which the second server device estimates that the target object is present in 3D space within the 3D map information.

7. The electronic system of claim 6, wherein the candidate coordinate calculation module determines candidate coordinates located at regular intervals within the candidate region, and
wherein the candidate coordinates indicate estimated latitudes, longitudes, and altitudes of the coordinates at which the target object is located, respectively.

8. The electronic system of claim 1, wherein the first server device is configured to:
calculate altitude angles between the candidate coordinates, coordinates of the camera device, and altitude correction coordinates of the candidate coordinates, respectively;
calculate angle errors between the altitude angles and the second angle, respectively; and
determine one of the candidate coordinates corresponding to a smallest one of the angle errors as the coordinates at which the target object is located, and
wherein the altitude correction coordinates indicate coordinates corrected such that altitudes of the candidate coordinates are identical to an altitude of the camera device.

9. A method of operating an electronic system including a camera device, a first server device, and a second server device, the method comprising:
providing, by the first server device, the camera device with an angle control signal for obtaining first image data corresponding to a first scene including a target object;
rotating, by the camera device, a camera of the camera device in a pan rotation direction by a first angle and in a tilt rotation direction by a second angle based on the angle control signal;
obtaining, by the camera device, the first image data;
providing, by the camera device, the first server device with the first image data and angle information indicating a rotation state of the camera; and
determining, by the second server device, estimated candidate coordinates of coordinates, at which the target object is located, in 3D space based on 3D map information and the angle information received from the first server device.

10. The method of claim 9, wherein the providing of the camera device with the angle control signal for obtaining the first image data includes:
providing, the camera device, the first server device with second image data corresponding to a second scene including the target object;
recognizing, by the first server device, the target object in the second image data;
detecting, by the first server device, pixel coordinates of the target object;
calculating, by the first server device, a pixel error corresponding to a result of comparing the pixel coordinates and center pixel coordinates of the second image data;
generating, by the first server device, the angle control signal based on the pixel error; and
providing, by the first server device, the angle control signal to the camera device.

11. The method of claim 9, wherein the determining of the estimated candidate coordinates of the coordinates, at which the target object is located, includes:
providing, by the first server device, the second server device with the angle information and a request signal for receiving the candidate coordinates;
determining, by the second server device, a candidate region of the target object based on the angle information and the 3D map information in response to the request signal, wherein the candidate region indicates a location at which it is estimated that the target object is present on a 3D map within the 3D map information; and
determining, by the second server device, the candidate coordinates based on the candidate region and the 3D map information.

12. The method of claim 9, further comprising:
calculating, by the first server device, altitude angles between the candidate coordinates, coordinates of the camera device, and altitude correction coordinates of the candidate coordinates;
calculating angle errors between the altitude angles and the second angle respectively; and
determining one of the candidate coordinates corresponding to a smallest one among the angle errors as the coordinate at which the target object is located, wherein the altitude correction coordinates are corrected such that altitudes of the candidate coordinates are identical to an altitude of the camera device.
